(19) United States
(12) Patent Application Publication
(10) Pub. No.: US 2025/0128386 A1
(43) Pub. Date: Apr. 24, 2025

(54) Tool with Anti Back-Out Flex Joint

(71) Applicant: Snap-on Incorporated, Kenosha, WI (US)

(72) Inventors: Daniel M. Eggert, Kenosha, WI (US); David T. Ross, Antioch, IL (US)

(21) Appl. No.: 18/381,623

(22) Filed: Oct. 18, 2023

(51) Int. Cl. B25B 23/00

(52) U.S. Cl. CPC B25B 23/0028

(57) ABSTRACT

A tool includes a handle, a yoke coupled to the handle, and a head. The yoke includes a first arm and a second arm defining a receiving portion therebetween. A through hole is defined by the first and second arms. The portion of the through hole defined by the second arm includes a first portion proximal to the receiving portion. The first portion has a first diameter and a first thread dimension. The portion of the through hole defined by the second arm also includes a second portion distal to the receiving portion. The second portion has a second diameter and second thread dimension different than the first portion. The head defines a bore and is disposed within the receiving portion such that the bore aligns with the through hole in the yoke.

### BACKGROUND

Handheld tools, such as wrenches and/or ratchets, are used in a variety of industries. The ratchet may be used for tightening or loosening a fastening device, such as a nut. A head of the ratchet may be engaged with the nut and rotation of a handle may produce torque on the nut through the head. As the handle is rotated, the torque in the head may cause forces on mating structure to deflect. Repeated use of the ratchet may cause repeated cycles of deflection on the mating structure. Repeated deflection may result in loosening of the coupling, such as loosening of a fastener, between the head and the handle and cause the fastener to back-out of a hole. The fastener backing-out of the hole may result in the head becoming loose or detaching from the handle, rendering the handheld tool unusable.

### OVERVIEW

In a first implementation, a tool is provided. The tool includes a handle, a yoke coupled to the handle, and a head. The yoke includes a first arm and a second arm defining a receiving portion therebetween. The yoke also includes a through hole defined by the first and second arms. The portion of the through hole defined by the second arm includes a first portion proximal to the receiving portion, where the first portion has a first diameter and a first thread dimension. The portion of the through hole defined by the second arm also includes a second portion distal to the receiving portion, where the second portion has a second diameter and second thread dimension different than the first portion. The head a bore and is disposed within the receiving portion such that the bore aligns with the through hole in the yoke.

In an embodiment of the tool, the first diameter is larger than the second diameter.

In an embodiment of the tool, the first thread dimension is a left-handed thread orientation, and the second thread dimension is a right-handed thread orientation.

In such embodiments of the tool, a thread pitch of the first portion is the same as a thread pitch of the second portion.

In an embodiment of the tool, the first thread dimension is a first thread pitch, and the second thread dimension is a second thread pitch.

In such embodiments of the tool, the first thread pitch is around 0.042 inch, and the second thread pitch is around 0.031 inch.

In an embodiment of the tool, the first and second portions include right-handed thread orientations.

In an embodiment of the tool, the first arm further includes a countersink or a counterbore, where the countersink or counterbore is distal to the receiving portion.

In an embodiment of the tool, the through hole defined by the first arm further includes a threaded portion proximal to the receiving portion

In such embodiments of the tool, the threaded portion of the first arm has a thread orientation the same as the first portion of the second arm.

In such embodiments of the tool, the threaded portion of the first arm has a thread pitch the same as the first portion of the second arm.

In an embodiment of the tool, the tool further includes a fastener disposed in the through hole and the bore, where the fastener couples the head to the first and second arms.

In such embodiments of the tool, the fastener comprises a smooth shank section and a threaded end section.

In such embodiments of the tool, the smooth shank section engages with the threads on the first portion of the second arm upon deflection of the second arm and the threaded end section couples with the second portion of the second arm.

In such embodiments of the tool, the through hole defined by the first arm further comprises a threaded portion proximal to the receiving portion. Upon deflection of the first arm the smooth shank section further engages with the threaded portion of the first arm.

In a second implementation, a tool is provided. The tool includes a handle, a yoke coupled to the handle, and a head. The yoke includes a first arm and a second arm defining a receiving portion therebetween. The yoke also includes a through hole defined by the first and second arms. The portion of the through hole defined by the second arm includes a first portion proximal to the receiving portion, where the first portion has a first diameter and a knurled pattern. The portion of the through hole defined by the second arm also includes a second portion distal to the receiving portion, where the second portion is threaded and has a second diameter different than the first diameter. The head defines a bore and is disposed within the receiving portion such that the bore aligns with the through hole in the yoke.

In an embodiment of the tool, the tool further includes a fastener disposed in the through hole and the bore. The fastener couples the head to the first and second arms. The fastener includes a smooth shank section and a threaded end section.

In such embodiments of the tool, the threaded end section couples with the second portion of the second arm. Upon deflection of the second arm the smooth shank section engages with the knurled pattern on the first portion.

In such embodiments of the tool, the through hole defined by the first arm further includes a knurled pattern proximal to the receiving portion. Upon deflection of the first arm the smooth shank section further engages with the knurled pattern.

In a third implementation, a method for reducing back-out of a fastener of a tool including a handle, a yoke coupled to handle, and a head. The yoke includes a first arm and a second arm defining a receiving portion therebetween, and a through hole defined by the first and second arms. The through hole on the second arm includes a first portion proximal to the receiving portion having a first diameter and a surface texture. The through hole on the second arm also includes a second portion distal to the receiving portion having a second diameter different than the first diameter, where the second portion is threaded. The head defines a bore and is disposed within the receiving portion such that the bore aligns with the through hole in the yoke. The fastener is disposed in the bore and the through hole and couples the head to the yoke. The method includes engaging the handle of the tool to produce torque in the head. The method also includes deflecting, based on the torque produced in the head, the first and second arm away from the receiving portion. The method further includes engaging, based on the deflection in the second arm, the surface texture with a smooth shank portion of the fastener such that migration of the fastener from the through hole is reduced.

In an embodiment of the method, the surface texture is a plurality of threads.

In an embodiment of the method, the surface texture is a knurled pattern.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1 illustrates a tool, according to an example embodiment.

FIG. 2A illustrates a cross-sectional view of a yoke of a tool, according to an example embodiment.

FIG. 2B illustrates a cross-sectional close-up view of a through hole on a second arm of a yoke, according to an example embodiment.

FIG. 2C illustrates a cross-sectional close-up view of a through hole on a second arm of a yoke, according to an example embodiment.

FIG. 3 illustrates a cross-sectional close-up view of a through hole on a first arm of a yoke, according to an example embodiment.

FIG. 4A illustrates cross-sectional view of a yoke of a tool, according to an example embodiment.

FIG. 4B illustrates a cross-sectional close-up view of a through hole on a second arm of a yoke, according to an example embodiment.

FIG. 5 illustrates a fastener, according to an example embodiment.

FIG. 6 illustrates a method for reducing back-out of a fastener of a tool, according to an example embodiment.

The drawings are schematic and not necessarily to scale. In the drawings, similar symbols typically identify similar components, unless context dictates otherwise.

### DETAILED DESCRIPTION

This description describes several example embodiments, at least some which relate to a tool for reducing back-out of a fastener. In example embodiments, the tool may include a yoke having a first arm and a second arm defining a through hole. The through hole on the second arm may include a first and second portion having different diameters, where the first portion includes a surface texture. During use on the tool, the second arm may deflect. Deflection of the second arm may engage the surface texture with a fastener disposed within the through hole. A likelihood of the fastener backing-out after repeated use of the tool may be reduced by engaging the surface texture with the fastener during deflection of the second arm.

In examples of the present disclosure, a tool is disclosed. More particularly, the tool may include a handle, a yoke coupled to the handle, and a head. A first and second arm of the yoke may define a receiving portion therebetween. A through hole may be defined by the first and second arms, where the portion of the through hole defined by the second arm includes a first portion proximal to the receiving portion and a second portion distal to the receiving portion. The first portion may include a first diameter and a first thread dimension, and the second portion may include a second diameter and second thread dimension different than the first portion. The head may define a bore and be disposed within the receiving portion such that the bore aligns with the through hole in the yoke. The fastener may be disposed within the through hole of the yoke and the bore of the head such that threading on the fastener couples with the threading of the second portion of the second arm. During use of the tool, the second arm may deflect due to torque produced from the head. Upon deflection of the second arm, the threads of the first portion may be engaged with a smooth shank portion of the fastener. Engagement of the first portion with the smooth shank portion of the fastener during deflection of the second arm may increase resistance on the fastener, reducing a likelihood of the fastener backing-out of the hole after repeated use.

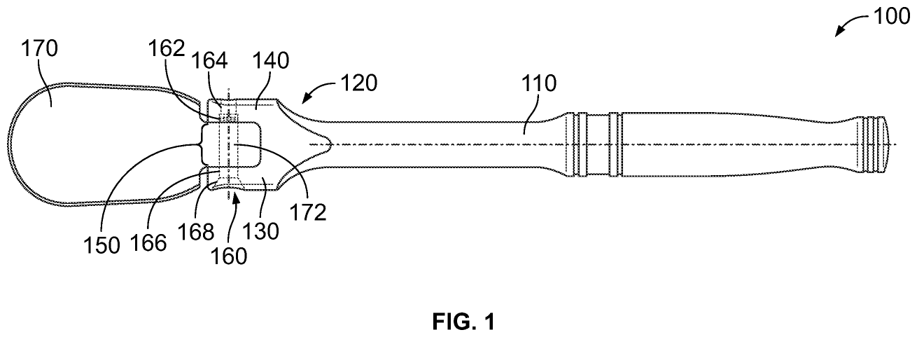

FIG. 1 depicts a tool 100, according to an example embodiment. The tool 100 includes a handle 110, a yoke 120 coupled to the handle 110, and a head 170 defining a bore 172. The yoke 120 includes a first arm 130 and a second arm 140 that define a receiving portion 150 therebetween. A through hole 160 is defined by the first and second arms 130 and 140. The portion of the through hole defined by the first arm includes a countersink 168 and a bore 166. The portion of the through hole defined by the second arm 140 includes a first portion 162 proximal to the receiving portion 150 and a second portion 164 distal to the receiving portion 150. The head 170 is disposed within the receiving portion 150 and couples to the first and second arms 130, 140, for example, by way of a fastener disposed within the through hole 160 and the bore 172. In some examples, the tool 100 is a handheld tool, such as a wrench or ratchet.

The tool 100 may be engaged with an object to cause rotation of the object, such as tightening and/or loosening of a nut. For example, the head 170 of the tool 100 may couple to the object and actuation of the handle 110 may cause the head 170 to exert force on the object to cause rotation. During use, torque produced between the head 170 and the object, such as through resisting forces in the object, may be transferred to the first and second arms 130, 140 by way of the fastener disposed within the bore 160. The torque produced in the head 170 and transferred to the first and second arms 130, 140 may cause the first and second arms 130, 140 to deflect. The first and second arms 130, 140 may deflect outwardly from the receiving portion 150. Upon deflection of the second arm 140, the first portion 162 may be configured to engage with the fastener disposed in the through hole 160 to increase interaction between the second arm 140 and the fastener. Increased interaction between the second arm 140 and the fastener may increase an amount of frictional resistance (e.g., grip) between the second arm 140 and the fastener, which may mitigate translation of the fastener in the through hole 160.

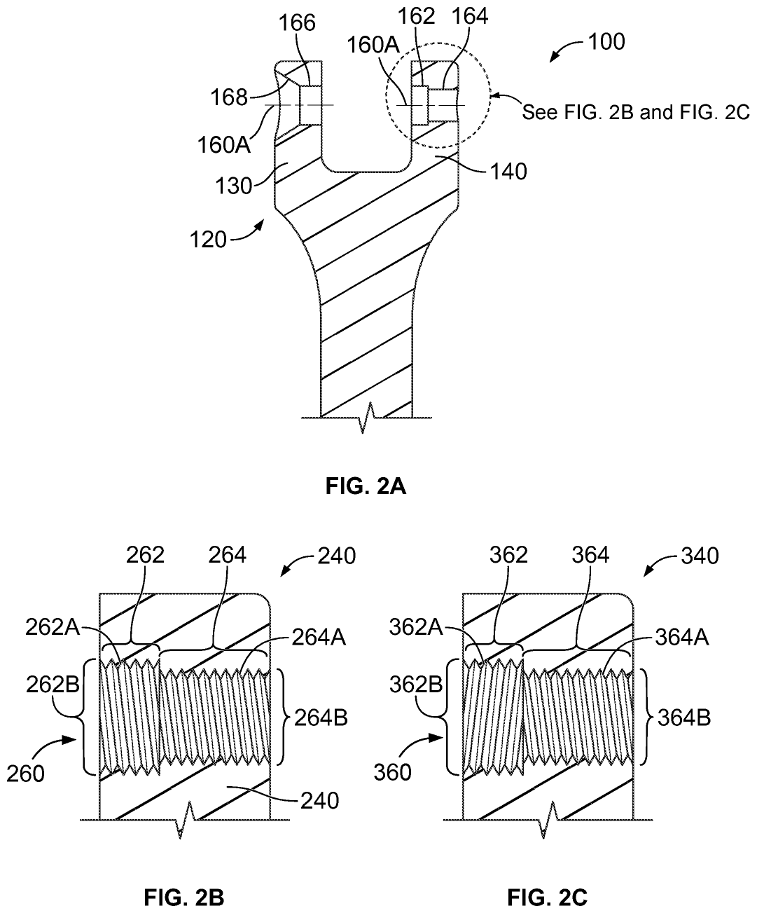

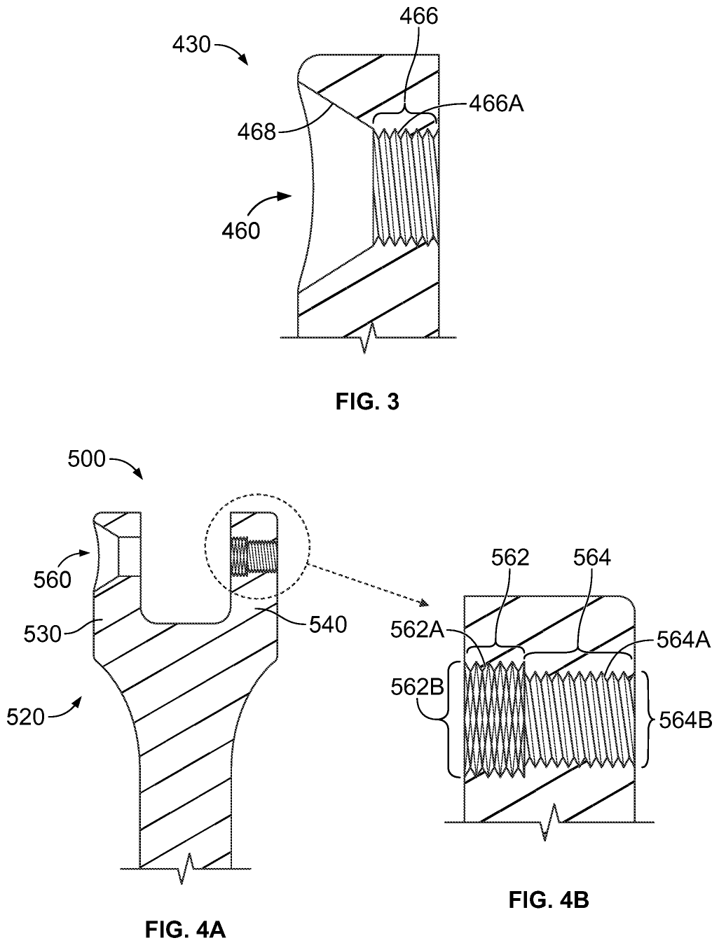

FIG. 2A depicts a cross-sectional view of the yoke 120 of the tool 100, according to an example embodiment. As shown, the through hole 160 includes a centerline 160A. Both the first arm 130 and the second arm 140 may have the same centerline 160A, such that the portion of the through hole 160 on the first arm 130 is aligned with the portion of the through hole 160 on the second arm 140. Similarly, the first portion 162 may be aligned with the second portion 164 via the centerline 160A, such that dimensions of the first and second portion 162, 164 are symmetric about the centerline 160A. In some examples, one or more dimensions of the first portion 162 may be different than one or more dimensions of the second portion 164. For example, a diameter and/or a surface texture of the first portion 162 may be different than a diameter and/or a surface texture of the second portion 164. The one or more dimensions of the first and second portion 162, 164 are further discussed in FIGS. 2B and 2C.

FIG. 2B depicts a cross-sectional close-up view of a through hole 260 on a second arm 240 of the yoke 120, according to an example embodiment. The through hole 260 on the second arm 240 includes a first portion 262, having a first thread dimension 262A and a first diameter 262B, and a second portion 264, having a second thread dimension 264A and a second thread diameter 264B. In some examples, the second arm 240 may be included on the tool 100.

Further, in some examples, the first diameter 262B may be different than the second diameter 264B. For example, the first diameter 262B may be larger than the second diameter 264B. In such examples, the second diameter 264B may be sized to provide coupling with a threaded portion of a fastener disposed within the through hole 260. The first diameter 262B may be larger than a smooth shank portion of the fastener, such that when the fastener is coupled with the second diameter 264B a clearance (e.g., a space or gap) exists between the first diameter 262B and the shank of the fastener while the second arm 240 is in a non-deflected state. In some examples, the first diameter 262B may be around 0.220 inch and the second diameter 264B may be around 0.197 inch. Providing the first diameter 262B larger than the second diameter 264B may allow the threaded portion of the fastener to be inserted into the second portion 264 with reduced interference from the first portion 262.

As shown, the first portion 262 includes the first thread dimension 262A and the second portion 264 includes the second thread dimension 264A. The first and second thread dimensions 262A, 264A may be located along the inner surface of the first and second diameters 262B, 264B respectively. In some examples, the first and/or second thread dimension 262A, 264A may be disposed along the entire perimeter (e.g., the inner surface) of the first and/or second diameter 262B, 264B. However, in other examples the first thread dimension 262A and/or second thread dimension 264A may be disposed along a portion of either the first diameter 262A and/or second diameter 264B. For example, a first length of the second diameter 264B may include the second thread dimension 264A along the perimeter, such as a length distal to the receiving portion 150, while a second length proximal to the receiving portion 150 may be smooth. The second thread dimension 264A may couple with the threads of the fastener, while the smooth portion of the second portion 264 may couple with the smooth shank portion of the fastener. Including both the thread dimension 264B and the smooth portion may allow for stresses produced in the head 170 to be more evenly distributed in the second arm 240.

In some examples the first and second thread dimensions 262A, 264A include a thread pitch, a thread orientation, a pitch diameter, and/or a thread angle. In some examples, the first and second thread dimensions 262A, 264A have a same thread pitch, while in other examples the first thread dimension 262A has a thread pitch different than the second thread dimension 264A, such as a first thread pitch different than a second thread pitch. The thread pitch may indicate the distance between one or more threads, such as number of threads per inch, on a threaded member. In some examples, the first thread dimension 262A is a first thread pitch of around 0.042 inch and the second thread dimension 264A is a second thread pitch of around 0.031 inch. The term around may account for machining tolerances that arise during the manufacturing process. “Around,” as used herein, may mean above or below the stated numerical value by a variance, such as a variance of between 0 and 5 percent, a variance of between 5 and 10 percent, a variance of between 10 and 15 percent, and a variance of between 15 and 20 percent.

In examples where the first and second thread dimensions 262A, 264A are the thread pitch, the thread pitch on the second portion 264 may be the same and/or similar to the thread pitch of the fastener. The thread pitch on the first portion 262 may be different than the thread pitch on the fastener, such as greater than or less than the fastener thread pitch. Thus, the second thread dimension 264A may facilitate coupling with the threads on the fastener while the first thread dimension 262A may not mate with the threads on the fastener.

Further, in examples where the first thread dimension 262A is a first thread pitch and the second thread dimension 264A is a second thread pitch different than the first thread pitch, the first portion 262 may have a thread orientation the same as a thread orientation on the second portion 264. For example, the first and second portions 262, 264 may both include right-handed and/or both include left-handed thread orientations.

FIG. 2C depicts a cross-sectional close-up view of a through hole 360 on a second arm 340 of the yoke 120, according to an example embodiment. The through hole 360 on the second arm 340 includes a first portion 362, having a first thread dimension 362A and a first diameter 362B, and a second portion 364 having a second thread dimension 364A and second diameter 364B. One or more aspects of the second arm 340 may be the same as and/or similar to the second arm 240 previously described with respect to FIG. 2B. In some examples, the second arm 340 may be included on the tool 100.

The first and second thread dimensions 362A, 364A may be a thread orientation (e.g., right-handed and/or left-handed). In some examples, the first thread dimension 362A may be different than the second thread dimension 364A. For example, as shown in FIG. 2C the first thread dimension 362A has a first thread orientation, such as the left-handed thread orientation, and the second thread dimension 364A has a second thread orientation, such as the right-handed thread orientation. Thus, the first thread dimension 362A may be a left-handed thread orientation and the second thread dimension 364A may be a right-handed thread orientation.

In some examples where the first portion 362 includes a left-handed thread orientation and the second portion 364 includes a right-handed thread orientation, the first and second portions 362, 364 may have a same thread pitch. For example, the first and second portions 362, 364 may both have a thread pitch of around 0.031 inch. However, in other examples the first and second portions 362, 364 may have different thread pitches and thread orientations from one another. For instance, the first portion 362 may include left-handed threads having a thread pitch of around 0.042 inch and the second portion 364 may include right-handed threads having a thread pitch of around 0.031 inch. Including different thread orientations and/or thread pitches between the first and second thread dimensions 362A, 364A may increase resistance, such as frictional resistance, of the second arm 340 to movement of the fastener. Thus, fastener back-out from the through hole 360 may be reduced by varying parameters of the first and second thread dimensions 326A, 364A.

The second arm 240, 340 shown in FIGS. 2B and 2C may deflect during use of the tool 100. For example, the head 170 may be engaged with an object (e.g., a nut or a spark plug) to cause rotation of the object. As the handle 110 is being actuated, torque produced in the head 170 may be transferred to the yoke 120 which may cause the second arm 240, 340 to deflect. Deflection of the second arm 240, 340 may engage the first portion 262, 362 with the fastener disposed in the through hole 260, 360. The first thread dimension 262A, 362A may be engaged with the fastener when the second arm 240, 340 is in the deflected state. The first thread dimension 262A, 362A may increase frictional resistance (e.g., grip) of the second arm 240, 340 on the fastener, such as on the smooth shank portion of the fastener, which may reduce a likelihood that the fastener migrates out of the through hole 260, 360 after repeated use of the tool 100. Thus, by varying the first thread dimension 262A, 362A to include differing thread pitches and/or thread orientations relative to the second thread dimension 264A, 364A potential back-out of the fastener in the through hole 260, 360 may be reduced.

FIG. 3 depicts a cross-sectional close-up view of a through hole 460 on a first arm 430 of the yoke 120, according to an example embodiment. The through hole 460 includes a countersink 468 and a bore 466 having a surface texture 466A. The through hole 460 may be included on the tool 100 shown and described with respect to FIG. 1. In examples where the tool 100 includes the through hole 460, the countersink 468 may be distal to the receiving portion 150 and the bore 466 may be proximal to the receiving portion 150. One or more dimensions of the countersink 468 may correspond to a head of a fastener configured to mate with the first arm 430, such as a fastener configured to be disposed within the through hole 460. While in the example described above in connection with FIG. 3 the through hole 460 has the countersink 468, in other examples a through hole of a first arm may have a counterbore.

A diameter of the through hole 460 on the bore 466 may be the same and/or similar to a diameter of the first or second portions 162, 164 on the second arm 140. In some examples, the bore 466 may allow for a level of clearance between the bore 466 and a fastener disposed within the bore 466. In such examples, the fastener may not engage the surface texture 466A when the first arm 430 is in a non-deflected state and may engage the fastener when the first arm 430 is in the deflected state. However, in other examples the fastener may lie flush with the bore 466 such that the surface texture 466A couples with the fastener in the non-deflected state.

In some examples, the surface texture 466A may be rough (e.g., non-smooth), such as including threads (e.g., left-handed and/or right-handed orientation) or knurling. In certain examples, the surface texture 466A includes a thread having a thread orientation the same as a thread orientation of first portion 162 of the second arm 140. In further examples, the surface texture 466A includes a thread having a thread pitch the same as a thread pitch on the first portion 162 of the second arm 140. Thus, one or more dimensions of the bore 466 may be the same as and/or similar to one or more dimensions of the first portion 162.

The surface texture 466A may extend an entire length of the bore 466 in some examples, while in other examples the surface texture 466A may extend a length less than the entire length of the bore 466. For example, distal to the receiving portion 150 the surface texture may extend between 0-10% the length of the bore 466, between 10-20% the length of the bore 466, between 20-30% the length of the bore 466, between 30-40% the length of the bore 466, between 40-50% the length of the bore 466, between 50-60% the length of the bore 466, between 60-70% the length of the bore 466, between 70-80% the length of the bore 466, between 80-90% the length of the bore 466, and between 90-100% the length of the bore 466. The surface texture 466A may increase frictional resistance between the bore 466 and the fastener during deflection of the first arm 130 which may reduce a likelihood of fastener translation/movement over time as a result of repeated use. In some examples, the tool 100 may be used in environments that experience temperature fluctuations. The temperature fluctuations may cause expansion or contraction of materials used in components of the tool 100. Increased frictional resistance between the bore 466 and the fastener during deflection may reduce the likelihood of fastener translation/movement when the components are expanded or contracted due to temperature fluctuations.

FIG. 4A depicts a cross-sectional view of a yoke 520 of a tool 500, according to an example embodiment. The yoke 520 includes a first arm 530 and a second arm 540 that define a through hole 560. The through hole 560 on the second arm 540 is shown and discussed further in FIG. 4B. The tool 500 may be the same and/or similar to the tool 100 described with respect to FIG. 1.

FIG. 4B depicts a cross-sectional close-up view of the through hole 560 on the second arm 540 of the yoke 520, according to an example embodiment. The through hole 560 on the second arm 540 includes a first portion 562 and a second portion 564. The first portion 562 is proximal to the receiving portion 150 (FIG. 1) and the second portion 564 is distal to the receiving portion 150.

The first portion 562 includes a first diameter 562B and a knurled pattern 562A. As shown, the knurled pattern 562A is disposed along the first diameter 562B on the first portion 562. The knurled pattern may include a plurality of straight lines, perpendicularly crossed-straight lines, angled lines, crossed-angled lines, helical lines, and/or crossed-helical lines. While the knurled pattern 562A is disposed along the entire perimeter of the first diameter 562B, in some examples the knurled pattern 562A may be disposed along a portion of the first diameter 562B. For example, a first length of the first diameter 562B may include the knurled pattern 562A along the perimeter, such as a length distal to the receiving portion 150, while a second length proximal to the receiving portion 150 may be smooth. Similarly, a cross-section of the first diameter 562B may include both the knurled pattern 562A and a smooth portion.

The second portion 564 includes a second diameter 564B and a thread dimension 564A. The thread dimension 564A may be the same as and/or similar to the thread dimensions 264B and/or 364B described with respect to FIGS. 2B and 2C. While the thread dimension 564A is disposed along the entire perimeter of the second diameter 564B, in some examples the thread dimension 564A may be disposed along a portion of the second diameter 564B. For example, a first length of the second diameter 564B may include the thread dimension 564A along the perimeter, such as a length distal to the first portion 562, while a second length proximal to the first portion 562 may be smooth.

In some examples, the first diameter 562B may be different than the second diameter 564B. For example, the first diameter 562B may be larger than the second diameter 564B. In examples where the first diameter 562B is larger than the second diameter 564B, a fastener may couple with the second diameter 564B and clearance may exist between the fastener and the first diameter 562B such that in a resting state of the tool 500 (e.g., when the tool 500 is not being used) the fastener and the knurled pattern 562A are not engaged.

The second thread dimension, shown respectively as 264A, 364A, 564A in FIGS. 2B, 2B, and 4B, may extend an entire length of the second portion in some examples, while in other examples the second thread dimension may extend a length less than the entire length of the the second portion. For example, distal to the receiving portion 150 the second thread dimension may extend between 0-10% the length of the second portion, between 10-20% the length of the second portion, between 20-30% the length of the second portion, between 30-40% the length of the second portion, between 40-50% the length of the second portion, between 50-60% the length of the second portion, between 60-70% the length of the second portion, between 70-80% the length of the second portion, between 80-90% the length of the second portion, and between 90-100% the length of the second portion. The second thread dimension may facilitate coupling with the fastener, while the unthreaded portion, for example a smooth portion, may allow for more even stress distribution in the second portion.

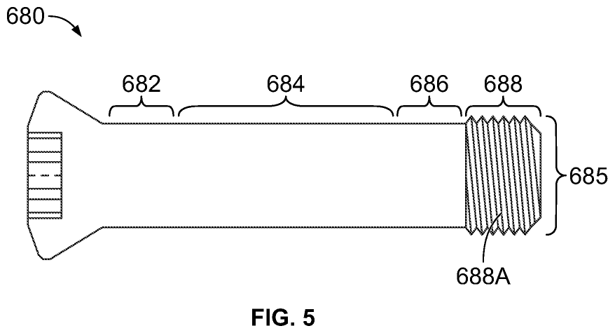

FIG. 5 depicts a fastener 680, according to an example embodiment. The fastener 680 includes a first shank portion 682, a second shank portion 684, a third shank portion 686, a threaded portion 688 having a thread dimension 688A, and a fastener diameter 685. The fastener 680 may be included on any of the tools 100 and/or 500 described above.

In some examples, the tool 100 includes the fastener 680 disposed in the through hole 160 and the bore 172, where the fastener 680 couples the head 170 to the first and second arms 130, 140. In such examples, the first shank portion 682 couples with the bore 166 on the first arm 130, the second shank portion 684 couples with the bore 172 on the head 170, the third shank portion 686 couples with the first portion 162 on the second arm 140, and the threaded portion 688 couples with the second portion 164 on the second arm 140.

The thread dimension 688A may include a thread pitch and/or a thread length. In some examples, the thread dimension 688A may correspond to (e.g., mirror) the thread dimension on the second portion 164. The thread dimension 688A may correspond to the thread dimension 264A and/or 364A, such that when the fastener 680 is disposed in the through hole 160 the threaded portion 688 mates with the threads on the second portion 164. For example, the thread pitch of the fastener 680 may be the same as the thread pitch of the second portion 164 to provide coupling of the threaded portion 688 with the second portion 164.

In some examples, the fastener diameter 685 may correspond to a diameter on the first arm 130, the second arm 140, and/or the head 170, such as corresponding to the diameter 264B and/or 364, the bore 166, and/or the bore 172. The fastener diameter 685 may be less than or equal to the diameter of mating parts on the tool 100 to allow the fastener 680 to be disposed within the yoke 120 and the head 170. The first, second, and third shank portions 682, 684, and 686 may have a smooth surface texture. A smooth surface texture on the first, second, and third shank portions 682, 684, and 686 may allow for torque produced in the head 170 during use to be more evenly and/or effectively transferred to the yoke 120. By more evenly and/or effectively transferring torque during use, damage to the tool 100 may be reduced and the life of the tool 100 may be increased.

In some examples, at least one of the first, second, and third shank portions 682, 684, 686 may be engaged with the yoke 120 and/or the head 170 when the second arm 140 is in an non-deflected state, and at least one of the first, second, and third shank portions 682, 684, 686 may be disengaged with the yoke 120 and/or the head 170 in the non-deflected state. When the second arm 140 is in a deflected state at least one of the shank portions that was previously in the disengaged state may be in an engaged state with the yoke 120 and/or the head 170.

For example, the threaded portion 288 may couple with the second portion 164 and upon deflection of the second arm 140, the third shank portion 686 engages with the threads (e.g., the thread dimension 262A) of the first portion 162 of the second arm 140. In another example, the tool 100 includes the first arm 430 having the surface texture 466A on the bore 466 (FIG. 3). In such examples, the first shank portion 682 may be disengaged with the bore 466 when the first arm 430 is in the non-deflected state and engaged with the bore 466 when the first arm 430 is in the deflected state. Thus, when the first arm 430 includes the surface texture 466A upon deflection of the first arm 430 the first shank portion 682 engages with the surface texture 466A. In some examples, the surface texture 466A includes threads, while in other examples the surface texture includes a knurled pattern.

Engagement of the fastener shank with either the threads of the first portion 162 and/or the surface texture 466A of the bore 466 during deflection may provide frictional resistance between the fastener 680 and the yoke 120. Frictional resistance between the fastener 680 and the yoke 120 may mitigate the likelihood of the fastener 680 becoming loose and backing-out of the through hole 160 after repeated use. Thus, by increasing frictional resistance on the fastener 680 during deflection of the first and/or second arms 130 and/or 140, fastener back-out that may occur over time may be reduced.

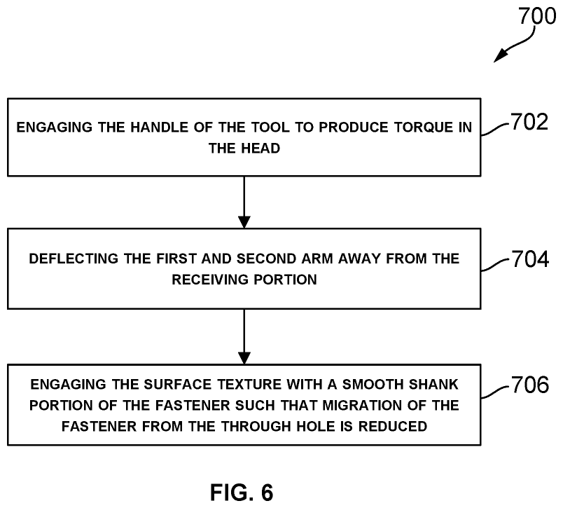

FIG. 6 shows a method 700 for reducing back-out of a fastener of a tool, according to an example embodiment. The tool includes a handle, a yoke coupled to handle, and a head. The yoke includes a first arm and a second arm defining a receiving portion therebetween, and a through hole defined by the first and second arms. The through hole on the second arm includes a first portion proximal to the receiving portion. The first portion having a first diameter and a surface texture. The through hole on the second arm also includes a second portion distal to the receiving portion. The second portion having a second diameter different than the first diameter. The second portion is threaded. The head defines a bore and is disposed within the receiving portion such that the bore aligns with the through hole in the yoke. The fastener is disposed in the bore and the through hole and couples the head to the yoke.

At block 702 the method 700 includes engaging the handle of the tool to produce torque in the head.

At block 704 the method 700 includes deflecting, based on the torque produced in the head, the first and second arm away from the receiving portion.

At block 706 the method 700 includes engaging, based on the deflection in the second arm, the surface texture with a smooth shank portion of the fastener such that migration of the fastener from the through hole is reduced.

In some examples, the surface texture is a plurality of threads.

In some examples, the surface texture is a knurled pattern.

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a device.

The use of ordinal numbers such as “first,” “second,” “third” and so on is to distinguish respective elements rather than to denote an order of those elements unless the context of using those terms explicitly indicates otherwise. Further, the description of a “first” element, such as a first arm and first portion, does not necessitate the presence of a second or any other element, such as a second arm and second portion.

Implementations of the present disclosure can thus relate to one of the enumerated examples (EE) listed below.

EE 1 is a tool comprising: a handle; a yoke coupled to the handle, the yoke comprising: a first arm and a second arm defining a receiving portion therebetween, and a through hole defined by the first and second arms, wherein the portion of the through hole defined by the second arm comprises: a first portion proximal to the receiving portion, wherein the first portion has a first diameter and a first thread dimension, and a second portion distal to the receiving portion, wherein the second portion has a second diameter and second thread dimension different than the first portion; and a head defining a bore and disposed within the receiving portion such that the bore aligns with the through hole in the yoke.

EE 2 is the tool of EE 1, wherein the first diameter is larger than the second diameter.

EE 3 is the tool of EE 2, wherein the first thread dimension is a left-handed thread orientation, and wherein the second thread dimension is a right-handed thread orientation.

EE 4 is the tool of EE 3, wherein a thread pitch of the first portion is the same as a thread pitch of the second portion.

EE 5 is the tool of any of EEs 2 and 4, wherein the first thread dimension is a first thread pitch, and wherein the second thread dimension is a second thread pitch.

EE 6 is the tool of EE 5, wherein the first thread pitch is around 0.042 inch, and wherein the second thread pitch is around 0.031 inch.

EE 7 is the tool of any of EEs 2 and 4-6, wherein the first and second portions comprise right-handed thread orientations.

EE 8 is the tool of any of EEs 1-7, wherein the first arm further comprises a countersink or a counterbore, wherein the countersink or counterbore is distal to the receiving portion.

EE 9 is the tool of any of EEs 1-7, wherein the through hole defined by the first arm further comprises a threaded portion proximal to the receiving portion.

EE 10 is the tool of EE 9, wherein the threaded portion of the first arm has a thread orientation the same as the first portion of the second arm.

EE 11 is the tool of EE 9, wherein the threaded portion of the first arm has a thread pitch the same as the first portion of the second arm.

EE 12 is the tool of any of EEs 1-11, further comprising a fastener disposed in the through hole and the bore, wherein the fastener couples the head to the first and second arms.

EE 13 is the tool of EE 12, wherein the fastener comprises a smooth shank section and a threaded end section.

EE 14 is the tool of EE 13, wherein the smooth shank section engages with the threads on the first portion of the second arm upon deflection of the second arm and the threaded end section couples with the second portion of the second arm.

EE 15 is the tool of EE 13, wherein the through hole defined by the first arm further comprises a threaded portion proximal to the receiving portion, and wherein upon deflection of the first arm the smooth shank section further engages with the threaded portion of the first arm.

EE 16 is a tool comprising: a handle; a yoke coupled to the handle, the yoke comprising: a first arm and a second arm defining a receiving portion therebetween, and a through hole defined by the first and second arms, wherein the portion of the through hole defined by the second arm comprises: a first portion proximal to the receiving portion, wherein the first portion has a first diameter and a knurled pattern, and a second portion distal to the receiving portion, wherein the second portion is threaded and has a second diameter different than the first diameter; and a head defining a bore and disposed within the receiving portion such that the bore aligns with the through hole in the yoke.

EE 17 is the tool of EE 16, further comprising a fastener disposed in the through hole and the bore, wherein the fastener couples the head to the first and second arms, and wherein the fastener comprises a smooth shank section and a threaded end section.

EE 18 is the tool of EE 17, wherein the threaded end section couples with the second portion of the second arm, and wherein upon deflection of the second arm the smooth shank section engages with the knurled pattern on the first portion.

EE 19 is the tool of EE 17, wherein the through hole defined by the first arm further comprises a knurled pattern proximal to the receiving portion, and wherein upon deflection of the first arm the smooth shank section further engages with the knurled pattern.

EE 20 is a method for reducing back-out of a fastener of a tool, wherein the tool comprises a handle, a yoke coupled to handle, and a head, wherein the yoke comprises a first arm and a second arm defining a receiving portion therebetween, and a through hole defined by the first and second arms, wherein the through hole on the second arm comprises a first portion proximal to the receiving portion and having a first diameter and a surface texture, and a second portion distal to the receiving portion and having a second diameter different than the first diameter, wherein the second portion is threaded, wherein the head defines a bore and is disposed within the receiving portion such that the bore aligns with the through hole in the yoke, and wherein the fastener is disposed in the bore and the through hole and couples the head to the yoke, the method comprising: engaging the handle of the tool to produce torque in the head; deflecting, based on the torque produced in the head, the first and second arm away from the receiving portion; and engaging, based on the deflection in the second arm, the surface texture with a smooth shank portion of the fastener such that migration of the fastener from the through hole is reduced.

EE 21 is the method of EE 20, wherein the surface texture is a plurality of threads.

EE 22 is the method of EE 20, wherein the surface texture is a knurled pattern.

What is claimed is:

1. A tool comprising:
a handle;
a yoke coupled to the handle, the yoke comprising:
a first arm and a second arm defining a receiving portion therebetween, and
a through hole defined by the first and second arms, wherein the portion of the through hole defined by the second arm comprises:
a first portion proximal to the receiving portion, wherein the first portion has a first diameter and a first thread dimension, and
a second portion distal to the receiving portion, wherein the second portion has a second diameter and second thread dimension different than the first portion; and
a head defining a bore and disposed within the receiving portion such that the bore aligns with the through hole in the yoke.

2. The tool of claim 1, wherein the first diameter is larger than the second diameter.

3. The tool of claim 2, wherein the first thread dimension is a left-handed thread orientation, and wherein the second thread dimension is a right-handed thread orientation.

4. The tool of claim 3, wherein a thread pitch of the first portion is the same as a thread pitch of the second portion.

5. The tool of claim 2, wherein the first thread dimension is a first thread pitch, and wherein the second thread dimension is a second thread pitch.

6. The tool of claim 5, wherein the first thread pitch is around 0.042 inch, and wherein the second thread pitch is around 0.031 inch.

7. The tool of claim 2, wherein the first and second portions comprise right-handed thread orientations.

8. The tool of claim 1, wherein the first arm further comprises a countersink or a counterbore, wherein the countersink or counterbore is distal to the receiving portion.

9. The tool of claim 1, wherein the through hole defined by the first arm further comprises a threaded portion proximal to the receiving portion.

10. The tool of claim 9, wherein the threaded portion of the first arm has a thread orientation the same as the first portion of the second arm.

11. The tool of claim 9, wherein the threaded portion of the first arm has a thread pitch the same as the first portion of the second arm.

12. The tool of claim 1, further comprising a fastener disposed in the through hole and the bore, wherein the fastener couples the head to the first and second arms.

13. The tool of claim 12, wherein the fastener comprises a smooth shank section and a threaded end section.

14. The tool of claim 13, wherein the smooth shank section engages with the threads on the first portion of the second arm upon deflection of the second arm and the threaded end section couples with the second portion of the second arm.

15. The tool of claim 13, wherein the through hole defined by the first arm further comprises a threaded portion proximal to the receiving portion, and wherein upon deflection of the first arm the smooth shank section further engages with the threaded portion of the first arm.

16. A tool comprising:
a handle;
a yoke coupled to the handle, the yoke comprising:
a first arm and a second arm defining a receiving portion therebetween, and
a through hole defined by the first and second arms, wherein the portion of the through hole defined by the second arm comprises:
a first portion proximal to the receiving portion, wherein the first portion has a first diameter and a knurled pattern, and
a second portion distal to the receiving portion, wherein the second portion is threaded and has a second diameter different than the first diameter; and
a head defining a bore and disposed within the receiving portion such that the bore aligns with the through hole in the yoke.

17. The tool of claim 16, further comprising a fastener disposed in the through hole and the bore, wherein the fastener couples the head to the first and second arms, and wherein the fastener comprises a smooth shank section and a threaded end section.

18. The tool of claim 17, wherein the threaded end section couples with the second portion of the second arm, and wherein upon deflection of the second arm the smooth shank section engages with the knurled pattern on the first portion.

19. The tool of claim 17, wherein the through hole defined by the first arm further comprises a knurled pattern proximal to the receiving portion, and wherein upon deflection of the first arm the smooth shank section further engages with the knurled pattern.

20. A method for reducing back-out of a fastener of a tool, wherein the tool comprises a handle, a yoke coupled to handle, and a head, wherein the yoke comprises a first arm and a second arm defining a receiving portion therebetween, and a through hole defined by the first and second arms, wherein the through hole on the second arm comprises a first portion proximal to the receiving portion and having a first diameter and a surface texture, and a second portion distal to the receiving portion and having a second diameter different than the first diameter, wherein the second portion is threaded, wherein the head defines a bore and is disposed within the receiving portion such that the bore aligns with the through hole in the yoke, and wherein the fastener is disposed in the bore and the through hole and couples the head to the yoke, the method comprising:
engaging the handle of the tool to produce torque in the head;
deflecting, based on the torque produced in the head, the first and second arm away from the receiving portion; and
engaging, based on the deflection in the second arm, the surface texture with a smooth shank portion of the fastener such that migration of the fastener from the through hole is reduced.
